(19) United States
(12) Patent Application Publication
(10) Pub. No.: US 2024/0114178 A1
(43) Pub. Date: Apr. 4, 2024

(54) SERVER AND METHOD

(71) Applicant: 17LIVE Japan Inc., Tokyo (JP)

(72) Inventors: Yun-An LIN, Taipei City (TW); Risa YANAGI, Tokyo (JP)

(21) Appl. No.: 18/342,772

(22) Filed: Jun. 28, 2023

(30) Foreign Application Priority Data
Oct. 4, 2022 (JP) 2022-159910

(51) Int. Cl. H04N 21/2187; H04N 21/2543

(52) U.S. Cl. CPC H04N 21/2187; H04N 21/25435

(57) ABSTRACT

One object is to systematically pick up from viewers what they want the livestreamer to do in a livestream. A server includes: a first receiving unit for receiving, from a terminal over a network, an input content entered on the terminal by a user, the input content being associated with a livestreamer of a livestream, the input content being representative of a matter that the user wants the livestreamer to do; an entry unit for entering the received matter that the user wants the livestreamer to do in a wish list associated with the livestreamer; and a notification unit for notifying the wish list to the livestreamer.

### CROSS-REFERENCE TO RELATED APPLICATIONS

This application is based on and claims the benefit of priority from Japanese Patent Application Serial No. 2022-159910 (filed on Oct. 4, 2022), the contents of which are hereby incorporated by reference in their entirety.

### TECHNICAL FIELD

The present disclosure relates to a server and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced. And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

In livestreaming, a voting function that allows viewers to voluntarily vote between two choices prepared by the livestreamer is known (see, for example, “How to View a Livestreaming Screen (Liver),” 17LIVE Inc., URL:https://17live-jp.zendesk.com/hc/ja/articles/4402915219087-% E9%85%8D % E4%13F % A1% E7% 94% BB % E9%9D % A2% E3%81% AE % E8% A6%8B % E6%96% B9-% E3%83% A9% E3% 82% A4% E3%83%90% E3%83% BC-).

If a livestream viewer has something he or she wants the livestreamer to do, in the current livestreaming system, the viewer can post in the comments what they want done. However, since many viewers post comments all the time, comments on what they want done will disappear from the livestreamer's view in a short time. In addition, since comments are essentially freely entered, it is difficult for livestreamers to get a statistical or systematic picture of what the viewers want done.

### SUMMARY

The present disclosure addresses these issues, and its purpose is to provide a technique that can systematically pick up from the viewers what they want the livestreamer to do in a livestream.

One aspect of the disclosure relates to a server. The server includes: a first receiving unit for receiving, from a terminal over a network, an input content entered on the terminal by a user, the input content being associated with a livestreamer of a livestream, the input content being representative of a matter that the user wants the livestreamer to do; an entry unit for entering the received matter that the user wants the livestreamer to do in a wish list associated with the livestreamer; and a notification unit for notifying the wish list to the livestreamer.

Another aspect of the disclosure relates to a server. The server includes: a receiving unit for receiving, upon selection of a predetermined object associated with a livestreamer of a livestream and displayed on a display of a user terminal of a user, the selection as a demand for performing a livestream to the livestreamer; and a notification unit for notifying, upon reception of the demand for performing a livestream to the livestreamer, the livestreamer that the demand for performing a livestream has been made.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### BRIEF DESCRIPTION OF THE DRAWINGS

FIG. 1 schematically illustrates a configuration of a livestreaming system according to a first embodiment.

FIG. 2 is a block diagram showing functions and configuration of a user terminal of FIG. 1.

FIG. 3 is a block diagram showing functions and configuration of a server shown in FIG. 1.

FIG. 4 is a data structure diagram showing an example of a stream DB in FIG. 3.

FIG. 5 is a data structure diagram showing an example of a user DB in FIG. 3.

FIG. 6 is a data structure diagram showing an example of a gift DB in FIG. 3.

FIG. 7 is a data structure diagram showing an example of a wish list DB in FIG. 3.

FIG. 8 is a data structure diagram showing an example of a fulfillment list DB in FIG. 3.

FIG. 9 is a flowchart showing a series of steps performed in the livestreaming system shown in FIG. 1.

FIG. 10 is a data structure diagram showing an example of a support setting DB in FIG. 3.

FIG. 11 is a representative screen image of a livestreaming room screen displayed on the display of the viewer's user terminal.

FIG. 12 is a representative screen image of a livestreaming room screen displayed on the display of the livestreamer's user terminal.

FIG. 13 is a representative screen image of a wish input screen displayed on the display of the viewer's user terminal.

FIG. 14 is a representative screen image of a wish list summary screen displayed on the display of the viewer's user terminal.

FIG. 15 is a representative screen image of a wish detail screen displayed on the display of the viewer's user terminal.

FIG. 16 is a representative screen image of a fulfillment list display screen displayed on the display of the livestreamer's user terminal.

FIG. 17 is a representative screen image of a fulfillment list display screen displayed on the display of an active user's user terminal.

FIG. 18 is a block diagram showing functions and configuration of a server according to a second embodiment.

FIG. 19 is a data structure diagram showing an example of a livestream demand DB in FIG. 18.

FIG. 20 is a flowchart showing a process related to a livestream demand performed in the livestreaming system according to the second embodiment.

FIG. 21 is a representative screen image of a profile screen displayed on the display of the active user's user terminal.

FIG. 22 is a representative screen image of a notification screen displayed on the display of the livestreamer's user terminal.

FIG. 23 is a representative screen image of a livestreaming room screen displayed on the display of the livestreamer's user terminal.

FIG. 24 is a block diagram showing an example of a hardware configuration of an information processing device according to the first embodiment.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

### First Embodiment

In a livestreaming system according to a first embodiment, viewers of the livestream submit what they want the livestreamer to do (hereinafter referred to as “wishes”) for a price, and the submitted wishes are entered in a wish list for the relevant livestreamer. The livestreaming system presents the wish list for the livestreamer of the livestream to the viewers of the livestream. Viewers pay a price to indicate their support for any of the wishes on the wish list that they also want the livestreamer to do. The livestreaming system notifies the livestreamer of the wish list along with the number of supports and encourages the livestreamer to fulfill the wishes. This allows the livestreamer to better know what his or her audience wants and to create live content that is more enjoyable to the viewers. The viewers will have the means to have their wishes reflected in the livestream. These result in more active interaction between the livestreamer and the viewers, and richer connections between the livestreamer and the viewers.

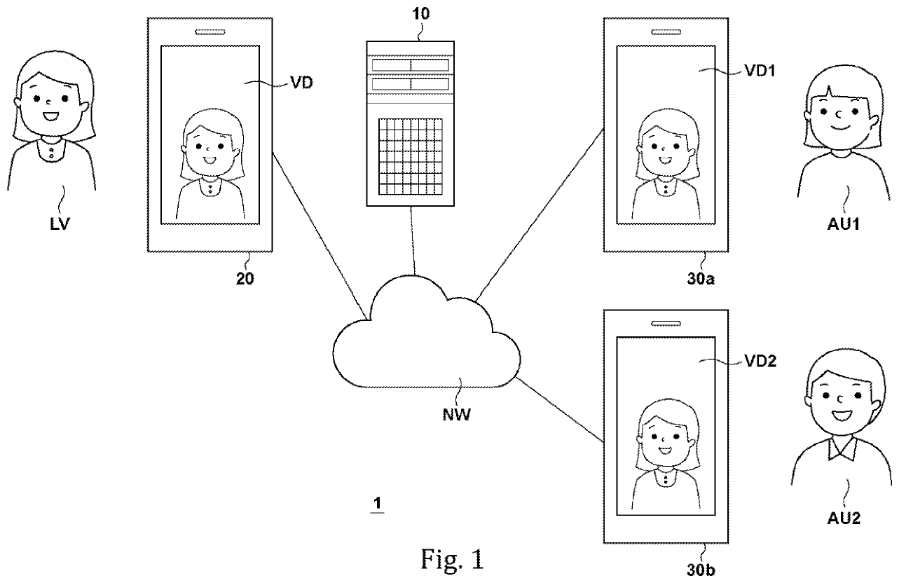

FIG. 1 schematically illustrates a configuration of a livestreaming system 1 according to the first embodiment. The livestreaming system 1 provides an interactive livestreaming service that allows a livestreamer LV (also referred to as a liver or streamer) and a viewer AU (also referred to as audience) (AU1, AU2, . . . ) to communicate in real time. As shown in FIG. 1, the livestreaming system 1 includes a server 10, a user terminal 20 on the livestreamer side, and user terminals 30 (30a, 30b, . . . ) on the audience side. In addition to the livestreamer who is livestreaming and the viewers who watch the livestream, there may be users who have logged in the livestreaming platform but is neither livestreaming nor watching the livestream. Such users are herein referred to as active users. The livestreamer, the viewers, and the active users may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 1. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform at their user terminals 30 to select and view a desired content. During livestreaming of the selected content, the viewers AU perform operations to comment and cheer via the user terminals 30, the livestreamer LV who is delivering the content responds to such a comment and cheer, and such response is transmitted to the viewers AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand type transmission, in which contents are entirely recorded and the entire data is once stored on the server, and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is played back on the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer's user terminal and then played back at the viewer's user terminal via the server 10, the video data generated at the livestreamer's user terminal, the video data that passes through the server 10, and the video data received and reproduced at the viewer's user terminal are all the same video data.

In the example in FIG. 1, the livestreamer LV is livestreaming his/her talk. The user terminal 20 of the livestreamer LV generates video data by recording images and sounds of the livestreamer LV who is talking, and the generated data is transmitted to the server 10 over the network NW. At the same time, the user terminal 20 displays the recorded video image VD of the livestreamer LV on the display of the user terminal 20 to allow the livestreamer LV to check what is to be streamed.

The user terminals 30a and 30b of the viewers AU1 and AU2 respectively, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes the livestreaming that enables the interactive communication, not one-way communication.

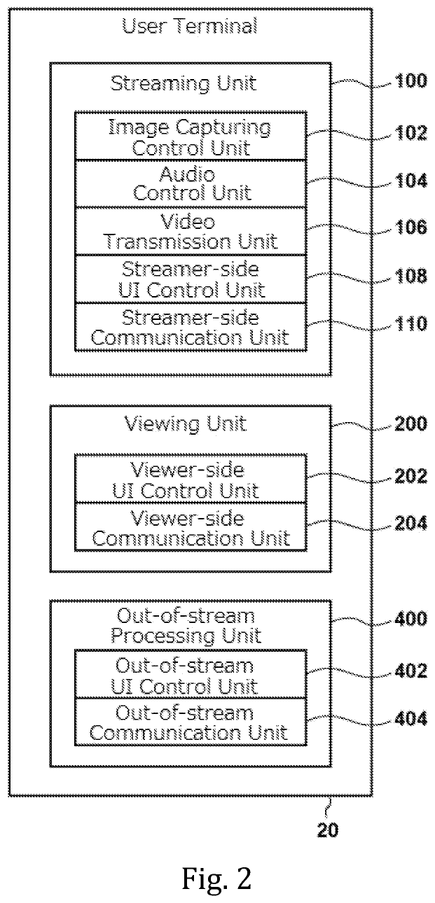

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The users download and install a livestreaming application program (hereinafter referred to as a livestreaming application) onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 by running the livestreaming application will be described as functions of the user terminals 20 and 30. These functions are realized in practice by the livestreaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a streaming unit 100 for recording the user's image and sound to generate and provide video data to the server 10, a viewing unit 200 for acquiring and reproducing the video data from the server 10, and an out-of-stream processing unit 400 for processing requests made by active users. The user activates the streaming unit 100 to livestream, the viewing unit 200 to view a livestream, and the out-of-stream processing unit 400 to look for a livestream, view a livestreamer's profile, or watch an archive. The user terminal having the streaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-stream processing unit 400 activated is the active user's terminal.

The streaming unit 100 includes an image capturing control unit 102, an audio control unit 104, a video transmission unit 106, a streamer-side UI control unit 108, and a streamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The streamer-side UI control unit 108 controls a UI for the livestreamer. The streamer-side UI control unit 108 is connected to a display (not shown in FIG. 2), and displays a video on the display by reproducing the video data that is to be transmitted by the video transmission unit 106. The streamer-side UI control unit 108 is also connected to input means (not shown in FIG. 2) such as touch panels, keyboards, and displays, and obtains the livestreamer's input via the input means. The streamer-side UI control unit 108 superimposes a predetermined frame image on the video image. The frame image includes various user interface objects (hereinafter simply referred to as “objects”) for receiving inputs from the livestreamer, comments entered by the viewers, and information obtained from the server 10. The streamer-side UI control unit 108 receives, for example, the livestreamer's inputs made by the livestreamer tapping the objects.

The streamer-side communication unit 110 controls communication with the server 10 during a livestream. The streamer-side communication unit 110 transmits the content of the livestreamer's input that has been obtained by the streamer-side UI control unit 108 to the server 10 over the network NW. The streamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-stream processing unit 400 includes an out-of-stream UI control unit 402 and an out-of-stream communication unit 404. The out-of-stream UI control unit 402 controls a UI for the active user. For example, the out-of-stream UI control unit 402 generates a livestream selection screen and shows the screen on the display. The livestream selection screen presents a list of livestreams to which the active user is currently invited to participate to allow the active user to select a livestream. The out-of-stream UI control unit 402 generates a profile screen for any user and shows the screen on the display. The out-of-stream UI control unit 402 plays back an archived past livestream, which is recorded and stored.

The out-of-stream communication unit 404 controls communication with the server 10 that takes place outside a livestream. The out-of-stream communication unit 404 receives, from the server 10 over the network NW, information necessary to generate the livestream selection screen, information necessary to generate the profile screen, and archived information. The out-of-stream communication unit 404 transmits the content of the active user's input to the server 10 over the network NW.

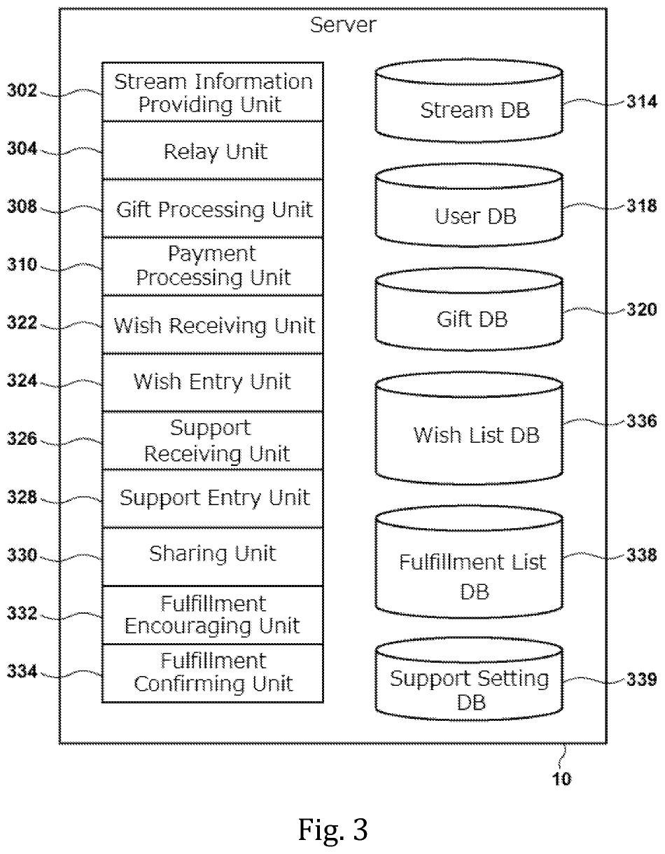

FIG. 3 is a block diagram showing functions and configuration of the server 10 of FIG. 1. The server 10 includes a stream information providing unit 302, a relay unit 304, a gift processing unit 308, a payment processing unit 310, a wish receiving unit 322, a wish entry unit 324, a support receiving unit 326, a support entry unit 328, a sharing unit 330, a fulfillment encouraging unit 332, a fulfillment confirming unit 334, a stream DB 314, a user DB 318, a gift DB 320, a wish list DB 336, a fulfillment list DB 338, and a support setting DB 339.

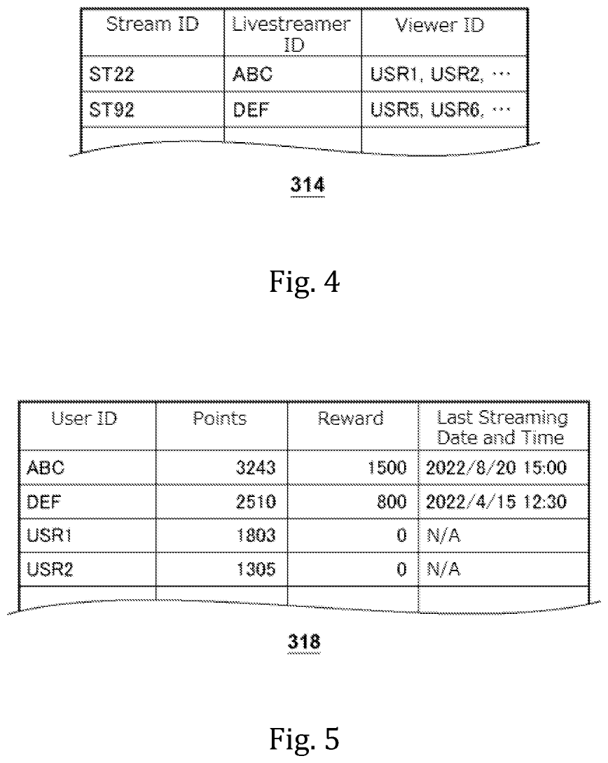

FIG. 4 is a data structure diagram showing an example of the stream DB 314 of FIG. 3. The stream DB 314 holds information regarding livestreams currently taking place. The stream DB 314 stores a stream ID identifying a livestream on a livestreaming platform provided by the livestreaming system 1, a livestreamer ID, which is a user ID identifying the livestreamer who provides the livestream, and a viewer ID, which is a user ID identifying a viewer of the livestream, in association with each other.

In the livestreaming platform provided by the livestreaming system 1 of the embodiment, when a user livestreams, the user is referred to as a livestreamer, and when the same user views a livestream streamed by another user, the user is referred to as a viewer. Therefore, the distinction between a livestreamer and a viewer is not fixed, and a user ID registered as a livestreamer ID at one time may be registered as a viewer ID at another time.

FIG. 5 is a data structure diagram showing an example of the user DB 318 of FIG. 3. The user DB 318 holds information regarding users. The user DB 318 stores a user ID identifying a user, points owned by the user, a reward awarded to the user, and a last streaming date and time of the last livestream performed by the user, in association with each other. The last streaming date and time is a representative time indicating when the last livestream was performed, and it may be the start or end time of the last livestream.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

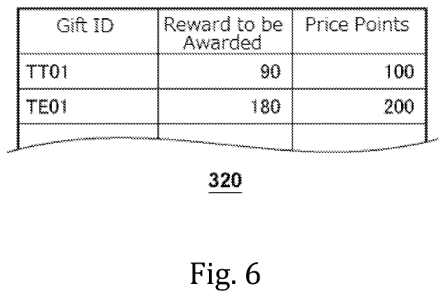

FIG. 6 is a data structure diagram showing an example of the gift DB 320 of FIG. 3. The gift DB 320 holds information regarding gifts available for the viewers within a livestream and gifts available for the active users outside a livestream. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is given a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator is able to desirably set the relationship between the reward to be awarded and the price points. For example, it may be set as the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

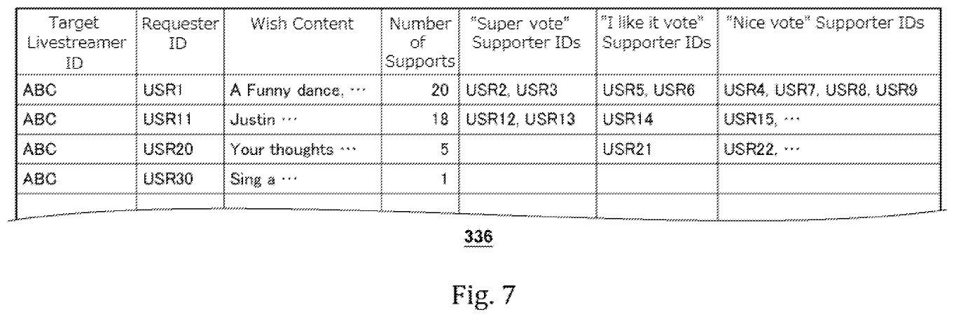

FIG. 7 is a data structure diagram showing an example of the wish list DB 336 of FIG. 3. The wish list DB 336 holds wish list information for each livestreamer. A wish list is a list of wishes for the corresponding livestreamer. The wish list DB 336 holds the target livestreamer ID, which is the user ID of the livestreamer who is the target of the wish, the requester ID, which is the user ID of the viewer who submitted the wish, the content of the wish, the number of supports for the wish (hereinafter referred to as the number of supports), the user IDs of the users who indicated their support with “Super vote,” the user IDs of the users who indicated their support by “I like it vote,” and the user IDs of the users who indicated their support by “Nice vote,” in association with each other. The first row of the example in FIG. 7 shows that the viewer “USR1” submitted a wish to the livestreamer “ABC” with the content “A funny dance, . . . ,” the number of supports for the wish is 20, two users “USR2” and “USR3” made “Super vote” for the wish, two users “USR5” and “USR6” made “I like it vote” for the wish, and four users “USR4,” “USR7,” “USR8,” and “USR9” made “Nice vote” for the wish.

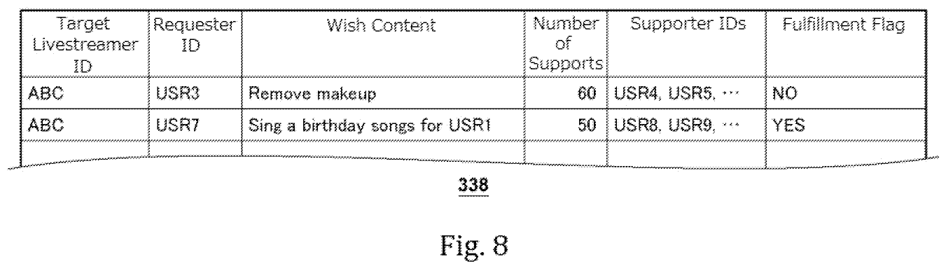

FIG. 8 is a data structure diagram showing an example of the fulfillment list DB 338 in FIG. 3. The fulfillment list DB 338 holds a fulfillment list (Dream-come-true list) for each livestreamer. The fulfillment list is a list of wishes for which a predetermined achievement encouraging condition has been satisfied. The fulfillment list DB 338 holds the target livestreamer ID of a wish for which a predetermined achievement encouraging condition has been satisfied, the requester ID of the wish, the content of the wish, the number of supports for the wish, the supporter IDs, which are the viewer IDs of the viewers who have indicated support for the wish, and the fulfillment flag, which indicates whether or not the wish has been fulfilled, in association with each other.

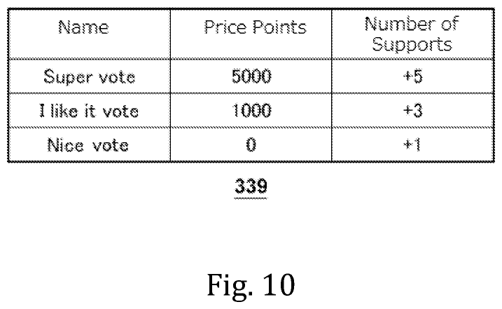

FIG. 10 is a data structure diagram showing an example of the support setting DB 339 in FIG. 3. The support setting DB 339 holds settings of support. In this embodiment, a higher price paid by a viewer results in a larger number of supports. In other words, the number of supports by a single viewer varies depending on the price paid. The support setting DB 339 holds, for each type of support, the name, the price points required to enter a support, and the number of supports that are added when the support is entered. In the example in FIG. 10, “Super vote” and “I like it vote” are supports that require payment of a price, while “Nice vote” is a support that does not require payment of a price.

Referring again to FIG. 3, upon reception of a notification from the user terminal 20 of the livestreamer that the livestreamer starts a livestream over the network NW, the stream information providing unit 302 enters in the stream DB 314 a stream ID identifying this livestream and the livestreamer ID of the livestreamer who performs the livestream. When the stream information providing unit 302 receives a request to provide information about livestreams from the out-of-stream communication unit 404 of a user terminal of an active user over the network NW, the stream information providing unit 302 retrieves currently available livestreams from the stream DB 314 and makes a list of currently available livestreams. The stream information providing unit 302 transmits the generated list to the requesting user terminal over the network NW The out-of-stream UI control unit 402 of the requesting user terminal generates a livestream selection screen based on the received list and shows the livestream selection screen on the display of the user terminal.

Once the out-of-stream UI control unit 402 of the user terminal receives the active user's selection result of the livestream on the livestream selection screen, the out-of-stream UI control unit 402 generates a stream request including the stream ID of the selected livestream, and transmits the stream request to the server 10 over the network NW. The stream information providing unit 302 starts providing, to the requesting user terminal, the livestream identified by the stream ID included in the received stream request. The stream information providing unit 302 updates the stream DB 314 such that the user ID of the active user of the requesting user terminal is included in the viewer IDs for the stream ID. In this way, the active user can be a viewer of the selected livestream.

The relay unit 304 relays the video data from the streamer-side user terminal 20 to the viewer-side user terminal 30 in the livestream started by the stream information providing unit 302. The relay unit 304 receives from the viewer-side communication unit 204 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the livestreamer ID of the livestreamer of the livestream that the viewer watches, and an object ID that identifies the object. When the object is a gift icon, the object ID is the gift ID. The object specifying signal in that case is a gift use signal indicating that the viewer uses a gift for the livestreamer. Similarly, the relay unit 304 receives from the streamer-side communication unit 110 of the streaming unit 100 in the user terminal 20 a signal that represents user input by the livestreamer during reproduction of the video data, such as the object specifying signal.

The gift processing unit 308 updates the user DB 318 so as to increase the reward for the livestreamer depending on the reward to be awarded of the gift identified by the gift ID included in the gift use signal. Specifically, the gift processing unit 308 refers to the gift DB 320 to specify a reward to awarded for the gift ID included in the received gift use signal. The gift processing unit 308 then updates the user DB 318 to add the specified reward to be awarded to the reward for the livestreamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

The wish receiving unit 322 receives, from the user terminal 30 over the network NW, the input content entered by the viewer into the user terminal 30. The input content is associated with the livestreamer of the livestream in which the viewer is participating. The input content is representative of a wish to the livestreamer. The input content may be, for example, text or a single choice selected from multiple options. The wish receiving unit 322 receives the input content as a wish on the condition of payment or acceptance of payment by the viewer.

More specifically, the wish receiving unit 322 receives a wish entry request from the viewer's user terminal 30 over the network NW during a livestream. The wish entry request includes the livestreamer ID of the livestreamer of the livestream, the viewer ID of the viewer of the requesting user terminal 30, information indicating the viewer's acceptance of payment of a price, and text indicating the content of the wish entered at the user terminal 30.

The wish entry unit 324 enters the wish received by the wish receiving unit 322 in the wish list associated with the livestreamer who is the target of the wish. More specifically, the wish entry unit 324 enters in the wish list DB 336 the livestreamer ID, the viewer ID, and the text included in the wish entry request received by the wish receiving unit 322 as the target livestreamer ID, the requester ID, and the wish content, respectively.

The support receiving unit 326 receives a support for a wish entered in the livestreamer's wish list from a viewer participating in the livestream of the livestreamer over the network NW. The support receiving unit 326 receives the support for the wish from the viewer, subject to the payment or acceptance of payment by the viewer. When receiving the support for the wish from the viewer, the support receiving unit 326 presents the viewer IDs of other viewers who have already supported the wish.

More specifically, the support receiving unit 326 receives a support entry request from a viewer's user terminal 30 over the network NW during a livestream. The support entry request includes the livestreamer ID of the livestreamer of the livestream, the content of the wish to be supported, the type of support, the information indicating the viewer's acceptance of the payment of the price, and the viewer ID of the viewer of the requesting user terminal 30.

The support entry unit 328 enters the support received by the support receiving unit 326 in the wish list DB 336. More specifically, the support entry unit 328 refers to the support setting DB 339 to identify the number of supports corresponding to the type of support included in the received support entry request. The support entry unit 328 updates the wish list DB 336 so that the identified number of supports is added to the number of supports corresponding to the livestreamer ID and the wish content included in the support entry request received by the support receiving unit 326. At the same time, the support entry unit 328 adds the viewer ID included in the support entry request to the supporter IDs. The supporter IDs are categorized by the type of support.

When the support receiving unit 326 receives a support from a viewer, the sharing unit 330 enables sharing by this viewer for seeking support for his/her wish. Sharing is accomplished by providing information to systems and services (e.g., social network services, messaging services, push notification services) other than the livestreaming platform realized by the livestreaming system 1. The technique for sharing is publicly known and will not be described herein.

The fulfillment encouraging unit 332 notifies the wish list held in the wish list DB 336 to the livestreamer corresponding to the wish list. The fulfillment encouraging unit 332 notifies to the livestreamer the wish entered in the wish list and the number of supports for the wish. The number of supports is an example of an indicator indicating the magnitude of support for the wish. In other embodiments, the magnitude of support may be indicated by the total of prices paid for the wish, the number of times the wish has been shared or the like.

The fulfillment encouraging unit 332 determines whether or not the achievement encouraging condition has been satisfied for each wish entered in the wish list DB 336. The achievement encouraging condition is, for example, that the number of supports exceeds a threshold value. The fulfillment encouraging unit 332 enters in the fulfillment list DB 338 the wishes for which the achievement encouraging conditions are determined to have been satisfied. The fulfillment encouraging unit 332 notifies during the livestream the wishes for which the achievement encouraging conditions are determined to have been fulfilled to the livestreamer and the viewers of the livestream.

The fulfillment confirming unit 334 determines for each wish entered in the fulfillment list DB 338 whether or not the wish has been fulfilled. The fulfillment confirming unit 334 receives a fulfillment entry request from the livestreamer's user terminal 20 over the network NW during livestream. The fulfillment entry request includes the livestreamer ID of the livestreamer of the livestream and the content of the wish that he/she thinks has been fulfilled. The fulfillment confirming unit 334 updates the fulfillment list DB 338 such that the fulfillment flag corresponding to the livestreamer ID and the wish content included in the received fulfillment entry request is changed from NO to YES. At the same time, the fulfillment confirming unit 334 deletes from the wish list DB 336 the wish corresponding to the livestreamer ID and the wish content included in the received fulfillment entry request.

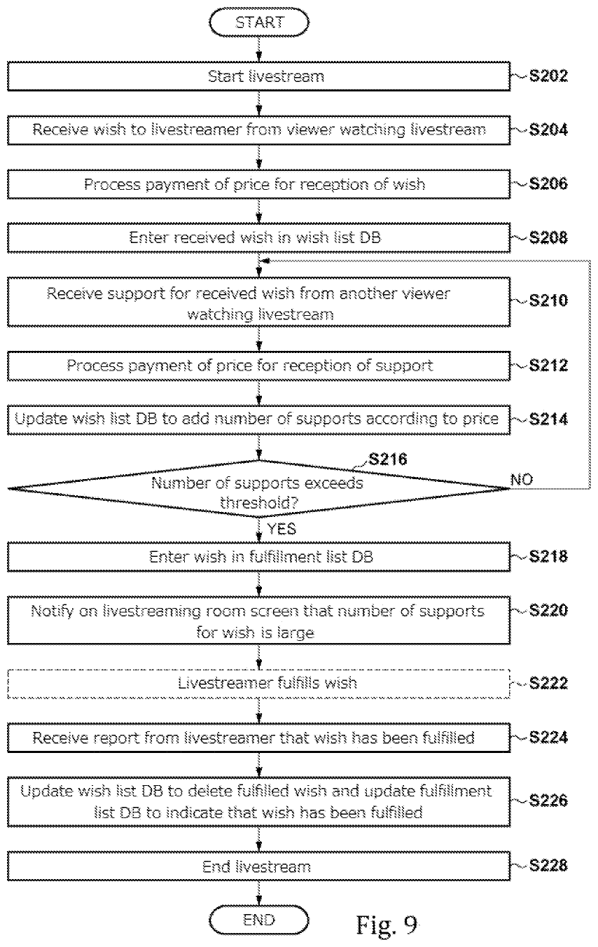

The operation of the livestreaming system 1 with the above configuration will be now described. FIG. 9 is a flowchart showing a series of steps performed in the livestreaming system 1. When the stream information providing unit 302 receives a notification from the user terminal 20 of the livestreamer that he/she starts livestream, the stream information providing unit 302 starts relaying the livestream (S202). Viewers can participate in the livestream started in step S202 by the process related to the stream request described above.

The wish receiving unit 322 receives a wish to the livestreamer from a viewer watching the livestream started in step S202 (S204). The wish receiving unit 322 receives a wish entry request from the viewer-side communication unit 204 of the viewer's user terminal over the network NW. The payment processing unit 310 processes the payment of the price for the reception of the wish (S206). The payment processing unit 310 processes the payment of the price by the requesting viewer in response to the reception of the wish entry request. The payment processing unit 310 updates the user DB 318 to subtract the price points for the wish entry from the points of the viewer identified by the viewer ID included in the wish entry request.

When the payment of the price is completed in step S206, the wish entry unit 324 enters the received wish in the wish list DB 336 (S208).

The support receiving unit 326 receives a support for the wish entered in step S208 from another viewer watching the livestream started in step S202 (S210). The support receiving unit 326 receives a support entry request from the viewer-side communication unit 204 of the user terminal of the other viewer over the network NW. The payment processing unit 310 processes the payment of the price for the reception of the support (S212). The payment processing unit 310 processes the payment of the price by the requesting other viewer in response to the reception of the support entry request. The payment processing unit 310 refers to the support setting DB 339 to identify the price points corresponding to the type of support included in the received support entry request. The payment processing unit 310 updates the user DB 318 to subtract the identified price points from the points of the viewer identified by the viewer ID included in the support entry request. If the support is of the type for which the price for reception is free, step S212 is skipped.

When the payment process of the price is completed in step S212, the support entry unit 328 updates the wish list DB 336 so as to add a predetermined number of supports in accordance with the price (S214).

For the wish for which the number of supports has been updated in step S214, the fulfillment encouraging unit 332 determines whether the updated number of supports exceeds a threshold value (S216). If the updated number of supports is equal to or less than the threshold value (NO in S216), the process returns to step S210. If the updated number of supports exceeds the threshold value (YES in S216), the fulfillment encouraging unit 332 enters the wish for which the number of supports has been updated in step S214 in the fulfillment list DB 338 (S218). The threshold value may be 20, 50, or 100, for example, and may be determined by the administrator as appropriate.

The fulfillment encouraging unit 332 notifies the livestreamer and the viewers on the livestreaming room screen of the livestream started in step S202 that the number of supports is large for the wish for which the number of supports has been updated in step S214 (S220). Upon viewing the notification, the livestreamer of the livestream will know that there is a large number of supports for the wish for which the number of supports has been updated in step S214. The livestreamer fulfills the wish (S222). The fulfillment confirming unit 334 receives a report from the livestreamer that the wish for which the notification was made in step S220 has been fulfilled (S224). The fulfillment confirming unit 334 updates the wish list DB 336 to delete the fulfilled wish and updates the fulfillment list DB 338 to indicate that the wish has been fulfilled (S226).

When the relay unit 304 receives a notification from the user terminal 20 of the livestreamer that he/she ends the livestream, the relay unit 304 ends the livestream by stopping the relay of the livestream (S228). The fulfillment confirming unit 334 deletes the wish list related to the ended livestream from the wish list DB 336. The fulfillment confirming unit 334 deletes the wishes related to the ended livestream from the fulfillment list DB 338. In other words, in this embodiment, the submission of wishes and entry of supports are only valid within the livestream. In other words, the wish list has a time limit, and the wish list will be deleted at the end of the livestream.

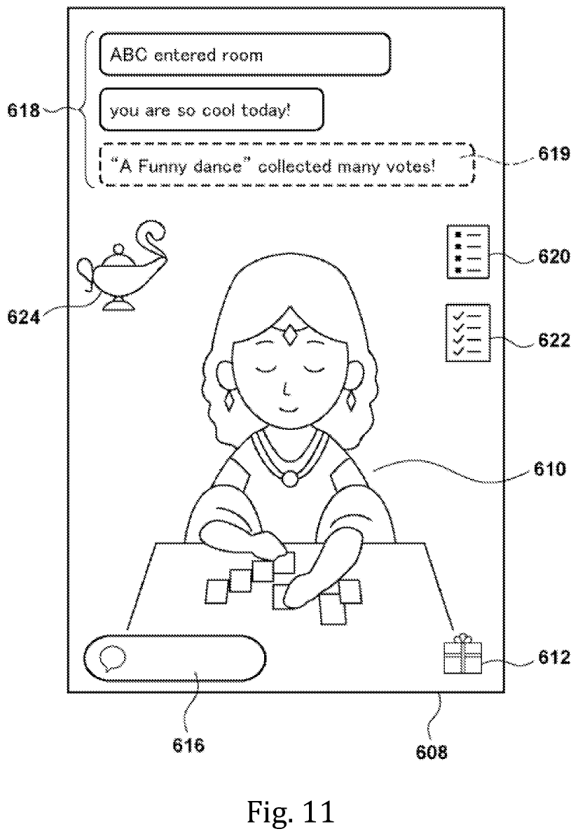

FIG. 11 is a representative screen image of a livestreaming room screen 608 shown on the display of the viewer's user terminal 30. The livestreaming room screen 608 displays a video image generated by the user terminal 20 of the livestreamer in real time. The livestreaming room screen 608 includes a video image 610 of a livestreamer obtained by reproducing the video data received from the server 10, a gift object 612 that allows the viewer to use a gift, a comment input region 616, a comment display region 618, a wish list object 620, a fulfillment list object 622, and a wish submitting object 624. The viewer-side UI control unit 202 superimposes objects such as the gift object 612, the comment input region 616, the comment display region 618, the wish list object 620, the fulfillment list object 622, and the wish submitting object 624 on the video image 610 obtained by reproducing the video data to generate the livestreaming room screen 608.

The comment display region 618 may include comments entered by the viewer using the user terminal 30 that displays the livestreaming room screen 608, comments entered by other viewers, comments entered by the livestreamer, and notifications from the system. The notifications from the system include information generated by the fulfillment encouraging unit 332 in relation to wishes for which the achievement encouraging conditions have been determined to be satisfied. In the example shown in FIG. 11, the number of supports for the wish “A Funny dance” has exceeded the threshold value, and thus the comment display region 618 includes the text 619 as a comment from the system indicating that there is a large number of supports for this wish. The viewer-side UI control unit 202 generates the comment display region 618 including comments of other viewers and the livestreamer and notifications from the system received from the server 10, and the viewer-side UI control unit 202 puts the generated comment display region 618 in the livestreaming room screen 608.

The comment input region 616 receives a comment input by the viewer. The viewer-side communication unit 204 generates a comment input signal that includes the comment entered in the comment input region 616, and transmits the signal to the server 10 over the network NW. At the same time, the viewer-side UI control unit 202 updates the comment display region 618 to display the comment entered in the comment input region 616.

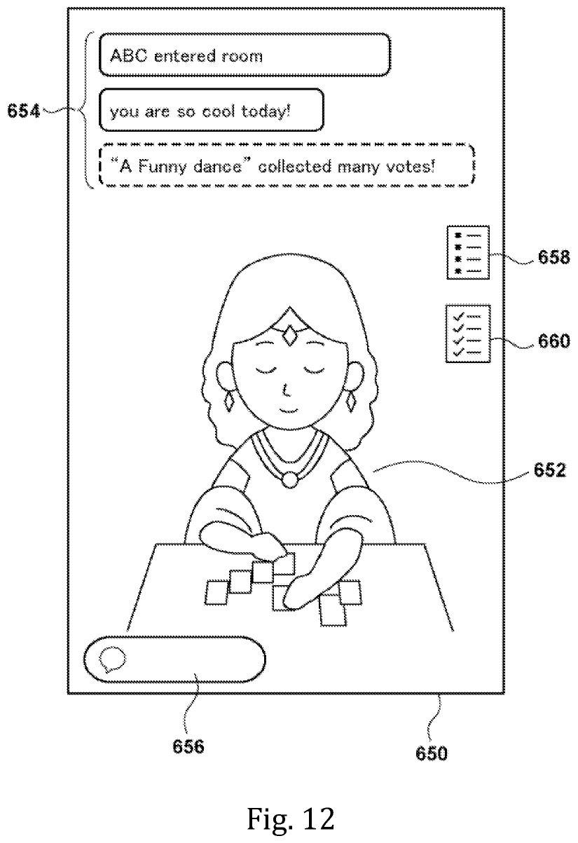

FIG. 12 is a representative screen image of the livestreaming room screen 650 shown on the display of the livestreamer's user terminal 20. The livestreaming room screen 650 includes a video image 652 of the livestreamer obtained by reproducing the video data generated on the livestreamer's user terminal 20, a comment display region 654 corresponding to the comment display region 618, a comment input region 656 corresponding to the comment input region 616, a wish list object 658, and a fulfillment list object 660.

The video image 652 is substantially the same as the video image 610 of the livestreaming room screen 608 shown on the display of the viewer's user terminal 30. The comment display region 654 is substantially the same as the comment display region 618 of the livestreaming room screen 608 displayed on the display of the viewer's user terminal 30.

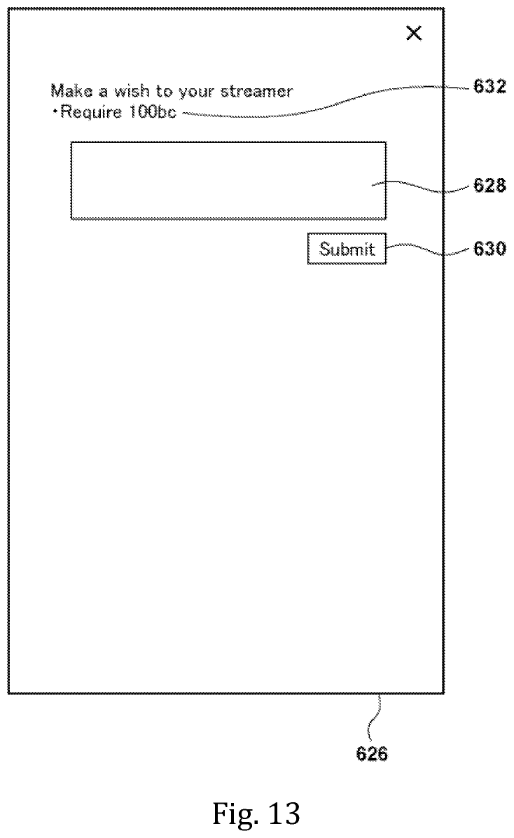

When a tap on the wish submitting object 624 in FIG. 11 is detected, the viewer-side UI control unit 202 of the user terminal 30 generates a wish input screen 626 to receive input of a wish to the livestreamer of the livestream being viewed, and displays it on the display of the user terminal 30. FIG. 13 is a representative screen image of a wish input screen 626 displayed on the display of the viewer's user terminal 30. The wish input screen 626 contains an input region 628 that receives text input by the viewer, a submitting button 630, and text 632 indicating the amount of price for the submission of a wish.

The viewer inputs text of his/her wish to the livestreamer into the input region 628 and taps the submitting button 630. When a tap on the submitting button 630 is detected, the viewer-side UI control unit 202 generates a wish entry request that includes the text input in the input region 628 as the text indicating the content of the wish. When a tap on the submitting button 630 is detected, the viewer-side UI control unit 202 receives it as an acceptance of payment of the price by the viewer. The viewer-side communication unit 204 sends the generated wish entry request to the server 10. The processing of the wish entry request at the server 10 has been described above.

When a tap on the wish list object 620 in FIG. 11 is detected, the viewer-side communication unit 204 of the user terminal 30 generates a wish list information request including the livestreamer ID of the livestreamer of the livestream being viewed, and sends it to the server 10 over the network NW. When receiving a wish list information request, the fulfillment encouraging unit 332 of the server 10 reads from the wish list DB 336 the wish list for the livestreamer identified by the livestreamer ID included in the request. Specifically, the fulfillment encouraging unit 332 obtains a wish list by reading from the wish list DB 336 and listing the requester ID, the wish content, the number of supports, and the supporter IDs (for each support type) of the wishes having the target livestreamer ID that matches the livestreamer ID included in the received wish list information request. The fulfillment encouraging unit 332 sends the obtained wish list to the requesting user terminal 30. The viewer-side UI control unit 202 of the user terminal 30 generates a wish list summary screen 634 for presenting the contents of the received wish list and displays it on the display of the user terminal 30.

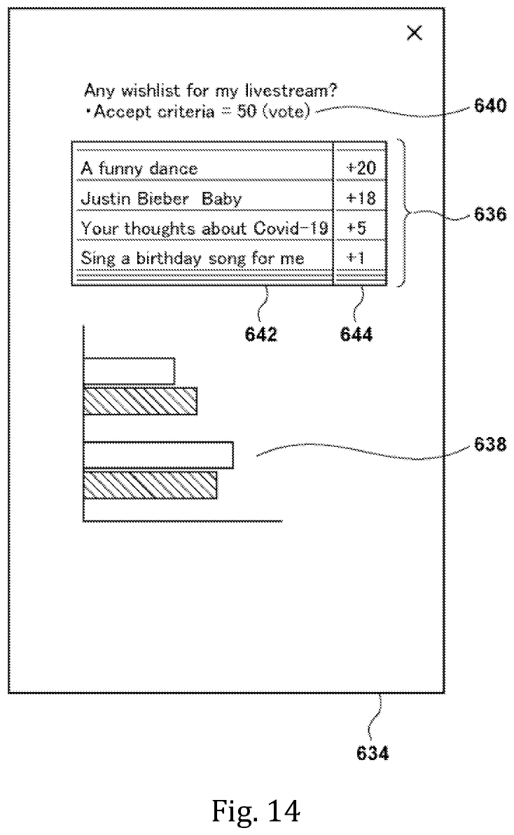

FIG. 14 is a representative screen image of a wish list summary screen 634 displayed on the display of the viewer's user terminal 30. The wish list summary screen 634 includes a list display region 636 that displays wishes for the livestreamer in a list form, a distribution display region 638, and a threshold display region 640. The list display region 636 displays, for each wish to the livestreamer, the wish content 642 and the number of supports 644 for the wish, in association with each other. The list display region 636 displays the wishes in the descending order of the number of supports 644, from top to bottom. The distribution display region 638 displays the distribution of supports. The threshold display region 640 displays the number of supports required to move a wish from the wish list to the fulfillment list.

The viewer views the wishes displayed in the list display region 636 in FIG. 14, and when finding an interesting wish, he/she taps the region where this wish is displayed. The viewer-side UI control unit 202 of the user terminal 30 generates a wish detail screen 670, which displays the details of the wish corresponding to the tapped region, and displays it on the display of the user terminal 30.

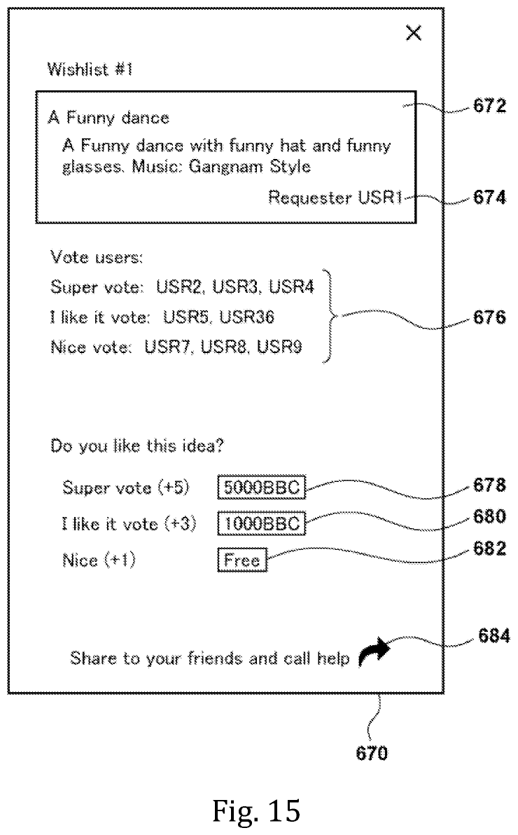

FIG. 15 is a representative screen image of a wish detail screen 670 displayed on the display of the viewer's user terminal 30. The wish detail screen 670 includes a detail display region 672 that displays the details of the wish specified by the viewer in FIG. 14, a requester display region 674 that displays the viewer ID of the viewer who submitted or requested the wish (i.e., requester ID), a supporter display region 676 that displays the viewer IDs of the viewers who support the wish (i.e., supporter IDs), a support button 678 for receiving a “Super vote” for the wish from the viewer viewing the wish detail screen 670, a support button 680 for receiving an “I like it vote” for the wish from the viewer viewing the wish detail screen 670, a support button 682 for receiving a “Nice vote” for the wish from the viewer viewing the wish detail screen 670, and a sharing button 684 for allowing the viewer viewing the wish detail screen 670 to share the wish with other viewers. The supporter display region 676 displays the supporter IDs for each type of support. Each of the support buttons 678, 680, and 682 shows the amount of price required to enter a corresponding support. Since the support corresponding to the support button 682 is free, the support button 682 shows the word “Free.”

The viewer reads the details of the wish displayed in detail display region 672. The viewer views the supporter display region 676 to learn of other viewers who have indicated their support for the wish. The viewer collectively reviews these details and decides that he/she supports the wish. The viewer selects one of three types of support and taps the support button for the selected type. When a tap on a support button is detected, the viewer-side UI control unit 202 generates a support entry request that includes the livestreamer ID of the livestreamer of the livestream, the content of the wish detailed on the wish detail screen 670, the type of support corresponding to the tapped support button, information indicating the viewer's acceptance of payment of the price, and the viewer ID of the viewer. When a tap on a support button is detected, the viewer-side UI control unit 202 receives it as an acceptance of payment of the price by the viewer. The viewer-side communication unit 204 sends the generated support entry request to the server 10. The processing of the support entry request at the server 10 has been described above.

When the viewer decides to share the wish displayed in the detail display region 672 with others, he/she taps the sharing button 684. When a tap on the sharing button 684 is detected, the viewer-side UI control unit 202 displays a pop-up screen (not shown) on the display to receive designation of a sharing target (e.g., service with which the wish is to be shared) from the viewer. When designation of a sharing target is received, the viewer-side UI control unit 202 generates a sharing request that includes the livestreamer ID of the livestreamer of the livestream, the content of the wish detailed on the wish detail screen 670, the service designated as a sharing target, and the viewer ID of the viewer. The viewer-side communication unit 204 sends the generated sharing request to the server 10. The sharing unit 330 of the server 10 performs sharing based on the received sharing request.

The processing performed at the livestreamer's user terminal 20 and the server 10 when a tap on the wish list object 658 in FIG. 12 is detected is similar to the above-described processing performed when a tap on the wish list object 620 in FIG. 11 is detected. In particular, the fulfillment encouraging unit 332 sends the wish list for the requesting livestreamer to the user terminal 20 of the requesting livestreamer. As a result, the livestreamer can view the list of wishes for himself/herself by viewing a wish list summary screen similar to the wish list summary screen 634 in FIG. 14. In addition, the livestreamer can view the details of a wish, the requester of the wish, and the supporters for the wish by viewing the wish detail screen similar to the wish detail screen 670 in FIG. 15. Note that the support buttons 678, 680, 682 and the sharing button 684 in FIG. 14 are not shown on the wish detail screen displayed to the livestreamer.

When a tap on the fulfillment list object 660 in FIG. 12 is detected, the streamer-side UI control unit 108 of the livestreamer's user terminal 20 generates a fulfillment list information request including the livestreamer ID of the livestreamer, and sends it to the server 10 over the network NW. When receiving the fulfillment list information request, the fulfillment confirming unit 334 of the server 10 reads from the fulfillment list DB 338 the fulfillment list for the livestreamer identified by the livestreamer ID included in the request. Specifically, the fulfillment confirming unit 334 obtains a fulfillment list by reading from the fulfillment list DB 338 and listing the requester ID, the wish content, the number of supports, the supporter IDs, and the fulfillment flag of the wishes having the target livestreamer ID that matches the livestreamer ID included in the received fulfillment list information request. The fulfillment confirming unit 334 sends the obtained fulfillment list to the requesting user terminal 20. The streamer-side UI control unit 108 of the user terminal 20 generates a fulfillment list display screen 688 for presenting the contents of the received fulfillment list and displays it on the display of the user terminal 20.

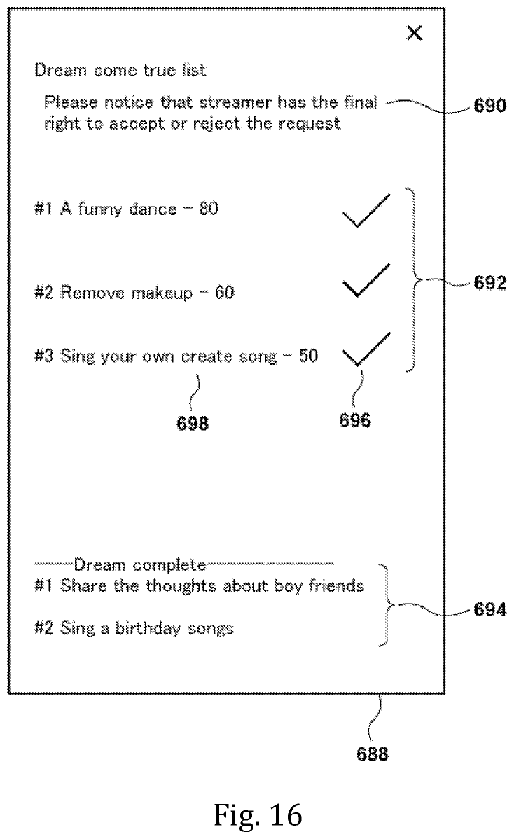

FIG. 16 is a representative screen image of a fulfillment list display screen 688 displayed on the display of the livestreamer's user terminal 20. The fulfillment list display screen 688 contains text 690 indicating that the livestreamer is not obligated to fulfill the wishes displayed in the fulfillment list, an unfulfilled wish display region 692 that displays, in a list form, the wishes entered in the received fulfillment list but not yet fulfilled (wishes with the fulfillment flag of NO), and a fulfilled wish display region 694 that displays, in a list form, the wishes entered in the received fulfillment list and already fulfilled (wishes with the fulfillment flag of YES). The unfulfilled wish display region 692 displays, for each unfulfilled wish, the content of the wish 698 and a fulfillment completion button 696 for receiving a fulfillment completion request for the wish, in association with each other.

When the livestreamer fulfills a wish displayed in the unfulfilled wish display region 692 in a livestream, the livestreamer taps the fulfillment completion button 696 corresponding to the wish. The streamer-side UI control unit 108 of the user terminal 20 generates a fulfillment entry request including the livestreamer ID of the livestreamer of the livestream and the content of the wish corresponding to the tapped fulfillment completion button 696, and sends it to the server 10 over the network NW. The processing of the fulfillment entry request at the server 10 has been described above. The processing performed at the viewer's user terminal 30 and the server 10 when a tap on the fulfillment list object 622 in FIG. 11 is detected is similar to the above-described processing performed when a tap on the fulfillment list object 660 in FIG. 12 is detected. Note that the fulfillment completion button 696 in FIG. 16 is not shown on the fulfillment list display screen displayed to the viewer.

In the above embodiment, an example of a holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

In the livestreaming system 1 according to this embodiment, viewers submit their wishes for the livestreamer, and the livestreamer receives a wish list listing the wishes for himself/herself. This allows the livestreamer to know more easily and accurately what his or her audience wants. As a result, the livestreamer can provide a livestream that is more enjoyable to the viewers.

In addition, in the livestreaming system 1 according to this embodiment, viewers can support their favorite wishes among those listed in the wish list. The wish list includes an indicator (in this example, the number of supports) that indicates the magnitude of support for the wish in association with the wish. Thus, a livestreamer viewing the wish list will be able to know the wishes receiving more supports among those for himself/herself. As a result, the wishes receiving more supports can be fulfilled preferentially, thus increasing the efficiency of the livestreaming.

In a livestream, the wishes receiving supports from more viewers are fulfilled by the livestreamer, and this facilitates the interaction between the livestreamer and the viewers and increases the satisfaction for both parties.

In the livestreaming system 1 according to this embodiment, viewers need to pay a price to submit their wishes. This will inhibit or prevent that a large number of irresponsible requests are submitted.

In the livestreaming system 1 according to this embodiment, viewers can select a type of support in accordance with the strength of their support. Therefore, the livestreaming system 1 can reflect the wishes of viewers who are willing to pay a large price to have their wishes fulfilled by the livestreamer, and the wishes of viewers who are not willing to pay a large price but would be happy to have their wishes fulfilled.

The configuration and operation of the livestreaming system 1 according to the first embodiment have been described above. This embodiment is merely an example, and it will be understood by those skilled in the art that various modifications are possible by combining the respective components and processes, and that such modifications are also within the scope of the present disclosure.

It has been described for this embodiment that the wishes and the supports are received during a livestream, but this is not limitative. For example, the wishes and the supports may be received and entered in a wish list regardless of whether or not a livestream is taking place. In this modification, for example, the livestreamer's profile screen or archive includes a wish submission object that leads to the wish input screen 626, a wish list object that leads to the wish list summary screen 634, and a fulfillment list object that leads to the fulfillment list display screen 688. The active user or the livestreamer can access these screens by tapping the objects on the profile screen or archive.

In this modification, when a schedule of a livestream corresponding to a wish to the livestreamer is generated, the fulfillment encouraging unit 332 notifies the schedule to the users supporting the wish. When the number of supports for a wish is updated, the fulfillment encouraging unit 332 determines whether or not the updated number of supports exceeds a threshold value. If the updated number of supports exceeds the threshold value, the fulfillment encouraging unit 332 displays on the livestreamer's user terminal 20 a screen (not shown) that receives a schedule of a livestream for fulfilling the wish for which the number of supports has been updated. The fulfillment encouraging unit 332 receives a schedule of a livestream from the livestreamer through this screen. The fulfillment encouraging unit 332 enters the wish having the updated number of supports and the received livestreaming schedule in the fulfillment list DB 338 in association with each other. The fulfillment encouraging unit 332 sends a notification including the livestreaming schedule to the user terminals of the users who support the wish for which the number of supports has been updated.

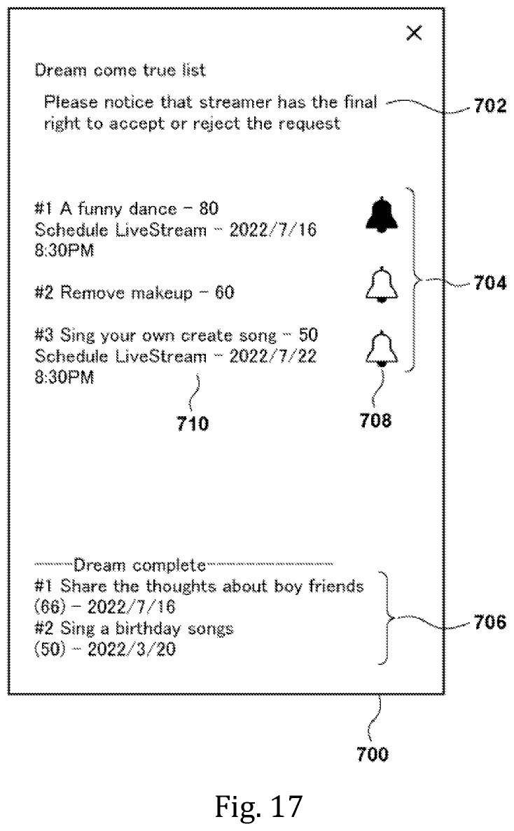

FIG. 17 is a representative screen image of a fulfillment list display screen 700 displayed on the display of an active user's user terminal. When an active user taps a fulfillment list object on the livestreamer's profile screen or archive, the out-of-stream UI control unit 402 generates and displays the fulfillment list display screen 700 by the same process as described with reference to FIG. 16. The fulfillment list display screen 700 contains text 702 similar to the text 690, an unfulfilled wish display region 704 that displays, in a list form, the wishes entered in the received fulfillment list but not yet fulfilled (wishes with the fulfillment flag of NO), and a fulfilled wish display region 706 that displays, in a list form, the wishes entered in the received fulfillment list and already fulfilled (wishes with the fulfillment flag of YES). The unfulfilled wish display region 704 displays, for each unfulfilled wish, the content of the wish, the livestreaming schedule 710, and a reminding button 708, in association with each other. When the active user taps the reminding button 708 in an inactive state, the out-of-stream UI control unit 402 enters the livestreaming schedule of the wish corresponding to the tapped reminding button 708 in the reminding list for the active user. The out-of-stream UI control unit 402 switches the tapped reminding button 708 from the inactive state to the active state. The out-of-stream UI control unit 402 notifies the active user when a livestreaming schedule entered in the reminding list approaches. The technique for reminding is well known and is not described herein.

In the embodiment, when the livestreamer fulfills a wish on the wish list or the fulfillment list, the livestreamer may be awarded a reward according to the price required for the submission of the wish and/or the price required for the entry of support for the wish. For example, the wish receiving unit 322 enters in the wish list DB 336 the received wish and a reward according to the price for submission of the wish, in association with each other. Similarly, the support receiving unit 326 also enters in the wish list DB 336 a reward according to the price for support. When confirming that the wish has been fulfilled, the fulfillment confirming unit 334 updates the user DB 318 such that the reward associated with the wish is added to the livestreamer's reward. In this case, confirmation of the fulfillment of the wish may be made without self-reporting by the livestreamer. For example, the fulfillment of a wish may be accepted and entered when the fulfillment of the wish is confirmed by more than a predetermined number of viewers.

In the embodiment, a wish is received on the condition of the acceptance of payment of a price by the viewer, but this is not limitative. For example, it is also possible that a wish is received on the condition of payment of a price by the viewer. When the condition is the payment of the price, it is also possible that, for example, the payment process of the required price is performed first, and then the text indicating the wish is received. The same applies to the price for support.

In the embodiment, supports are divided into three types requiring different prices to be paid, but this is not limitative. It is also possible that, for example, only free support is provided. In this case, all viewers have an equal vote.

### Second Embodiment

In the livestreaming system according to the second embodiment, when the period during which the livestreamer does not perform a livestream exceeds a predetermined period, a livestream demand object starts to be displayed on the profile screen of the livestreamer to receive from active users a demand for performing a livestream (hereinafter referred to as “a livestream demand”) to the livestreamer. An active user (e.g., a viewer who has been continuously watching the livestream performed by the livestreamer in the past) who longs for the livestream performed by the livestreamer browses the profile screen of the livestreamer and taps the livestream demand object. When the livestream demand object is tapped, the server notifies the livestreamer that a livestream demand has been made. This allows the active user to inform the livestreamer of the livestream demand with a small effort of tapping the object. The livestreamer can be motivated to perform a livestream by receiving a notification that a livestream demand has been made.

In the description of this embodiment, a user who performed a livestream in the past but is not currently performing a livestream is also referred to as “a livestreamer.”

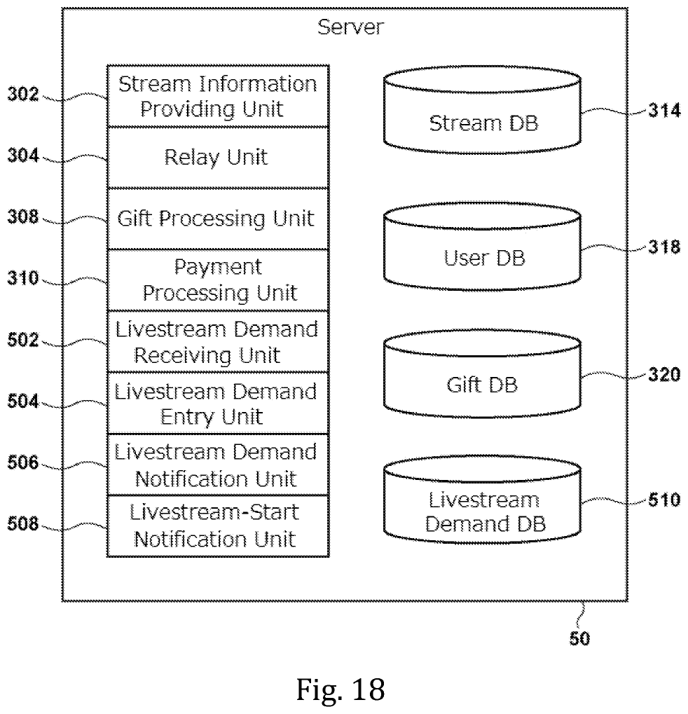

FIG. 18 is a block diagram showing functions and configuration of a server 50 according to the second embodiment. The server 50 includes a stream information providing unit 302, a relay unit 304, a gift processing unit 308, a payment processing unit 310, a livestream demand receiving unit 502, a livestream demand entry unit 504, a livestream demand notification unit 506, a livestream-start notification unit 508, a stream DB 314, a user DB 318, a gift DB 320, and a livestream demand DB 510.

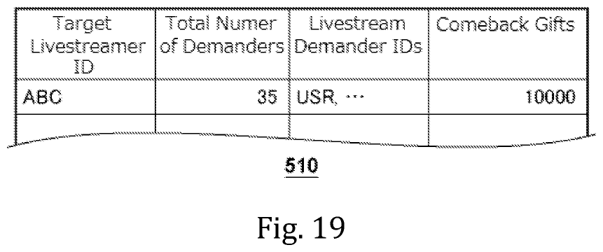

FIG. 19 is a data structure diagram showing an example of a livestream demand DB in FIG. 18. The livestream demand DB 510 holds information on livestream demands received from active users. The livestream demand DB 510 stores the target livestreamer ID, which is the livestreamer ID of the livestreamer who is demanded to perform the livestream, the total number of demanders, which is the total number of active users demanding the livestream by the livestreamer, the livestream demander IDs, which are the user IDs of these active users, and the total of comeback gifts, in association with each other. A comeback gift is a reward corresponding to the price paid by an active user to submit a livestream demand. A livestreamer can receive a comeback gift on the condition of performing a livestream.

Returning to FIG. 18, when an active user selects a livestream demand object associated with a livestreamer of a livestream and displayed on the display of the user terminal of the active user, the livestream demand receiving unit 502 receives the selection as a livestream demand to the livestreamer.

The livestream demand object may be located on a screen that can be viewed by the active user and associated with a particular livestreamer, such as the livestreamer's profile screen or archive selection screen. The following describes the case where the livestream demand object is located on the livestreamer's profile screen.

The livestream demand object is shown on the profile screen of a livestreamer when the length of the period for which the livestreamer has not been livestreaming exceeds the threshold value. In other words, the livestreamer's profile screen starts showing the livestream demand object when the length of the period for which the livestreamer has not been livestreaming exceeds the threshold value. The livestream demand object is not shown on the livestreamer's profile screen displayed within a predetermined period from the last livestream of the livestreamer.

An active user requests the user terminal to display the profile screen of his/her favorite livestreamer. The out-of-stream communication unit 404 of the active user's user terminal generates a profile information request including the streamer ID of the streamer specified by the active user, and sends the profile information request to the server 50 over the network NW. The livestream demand receiving unit 502 obtains, from a holding unit (not shown), the profile information of the livestreamer identified by the livestreamer ID included in the received profile information request. The livestream demand receiving unit 502 refers to the user DB 318 to obtain the livestream date and time of the last livestream of the livestreamer. The livestream demand receiving unit 502 determines whether the length of the period from the obtained livestream date and time to the present exceeds a threshold value (e.g., one week or one month). When determining that the threshold value is exceeded, the livestream demand receiving unit 502 sets an object flag to On and includes the object flag in the profile information. Otherwise, the livestream demand receiving unit 502 sets the object flag to Off. The livestream demand receiving unit 502 sends the profile information including the object flag to the requesting user terminal over the network NW. Based on the received profile information, the out-of-stream UI control unit 402 of the user terminal generates a profile screen and shows the generated screen on the display. At this time, when the object flag included in the profile information is set to On, the out-of-stream UI control unit 402 includes the livestream demand object in the profile screen. When the object flag is set to Off, the livestream demand object is not shown.

When detecting a tap on the livestream demand object shown on the livestreamer's profile screen, the out-of-stream communication unit 404 generates a livestream demand entry request that includes the livestreamer's livestreamer ID and the user ID of the active user who tapped the object, and sends it to the server 50 over the network NW. When receiving a livestream demand entry request, the livestream demand receiving unit 502 recognizes that the livestream demand object has been selected on the profile screen of the livestreamer identified by the livestreamer ID included in the request. The livestream demand receiving unit 502 receives the selection as a livestream demand to the livestreamer.

The livestream demand entry unit 504 enters the livestream demand received by the livestream demand receiving unit 502 in the livestream demand DB 510. More specifically, the livestream demand entry unit 504 determines whether or not the livestreamer ID included in the livestream demand entry request received by the livestream demand receiving unit 502 is already entered in the target livestreamer ID of the livestream demand DB 510. When the livestreamer ID is already entered, i.e., when there is already a target livestreamer ID that corresponds to the livestreamer ID included in the livestream demand entry request, the livestream demand entry unit 504 adds 1 to the total number of demanders corresponding to the target livestreamer ID, and also adds the user ID included in the livestream demand entry request to the corresponding livestream demander ID. When the livestream ID is not yet entered, i.e., when there is no target livestreamer ID that corresponds to the livestreamer ID included in the livestream demand entry request, the livestream demand entry unit 504 generates a new entry in the livestream demand DB 510. The livestream demand entry unit 504 enters the livestreamer ID included in the livestream demand entry request in the target livestreamer ID of the entry, enters 1 in the total number of demanders of the entry, and enters the user ID included in the livestream demand entry request in the livestream demander ID of the entry.

In this embodiment, there are two types of livestream demands: free (no price required) and charged (price required). In a charged livestream demand, the livestream demand receiving unit 502 receives a livestream demand to the livestreamer on the condition of payment or acceptance of payment of the price by the active user. More specifically, when an active user taps a livestream demand object corresponding to a charged livestream demand on the livestreamer's profile screen, the out-of-stream UI control unit 402 receives the tap on the livestream demand object as an acceptance of payment of the price by the active user. The out-of-stream communication unit 404 includes information indicating the active user's acceptance of payment of the price in the livestream demand entry request. When receiving the livestream demand entry request, the payment processing unit 310 processes the payment of the price by the active user. The livestream demand entry unit 504 adds the reward corresponding to the price to the total of comeback gifts or enters a new entry in the livestream demand DB 510. The relationship between the price and the reward may be set as appropriate by the administrator of the livestreaming platform.

When the livestream demand to the livestreamer is received, the livestream demand notification unit 506 notifies the livestreamer that the livestream demand has been made. In addition, the livestream demand notification unit 506 notifies the total number of demanders and/or the total of comeback gifts of the livestream demand to the livestreamer. The total number of demanders is an example of an indicator indicating the magnitude of the livestream demand to the target livestreamer. The total of comeback gifts is another example of an indicator indicating the magnitude of the livestream demand to the target livestreamer. When the total number of demanders for the target livestreamer entered in the livestream demand DB 510 exceeds the threshold value, the livestream demand notification unit 506 notifies the target livestreamer that a livestream demand has been made (hereinafter referred to as “livestream demand notification”). The livestream demand notification unit 506 performs the livestream demand notification by sending to the target livestreamer's user terminal a notification including text indicating that a livestream demand has been made and the total number of demanders.

When the target livestreamer entered in the livestream demand DB 510 starts a livestream or makes a reservation for performing a livestream, the livestream-start notification unit 508 notifies the livestream demanders entered in the livestream demand DB 510 in association with the target livestreamer. When the stream information providing unit 302 receives the start of livestream, the livestream-start notification unit 508 determines whether or not the livestreamer of the livestream is entered as a target livestreamer in the livestream demand DB 510. In the case where the livestreamer is entered as a target livestreamer, the livestream-start notification unit 508 specifies the livestream demanders stored in association with the target livestreamer. The livestream-start notification unit 508 sends a notification including text indicating that the livestream of the target livestreamer has been started to the user terminals of the specified livestream demanders. In the case where the livestreamer is not entered as a target livestreamer, the livestream-start notification unit 508 does not perform notification. When a reservation for performing a livestream by a livestreamer is received, the livestream-start notification unit 508 performs notification to the corresponding livestream demanders by the same process. When a target livestreamer entered in the livestream demand DB 510 starts a livestream, the livestream-start notification unit 508 deletes the entry related to the target livestreamer from the livestream demand DB 510.

The livestream-start notification unit 508 performs the process for awarding the total of comeback gifts to the target livestreamer entered in the livestream demand DB 510 on the condition that the livestreamer performs a livestream. The livestream-start notification unit 508 updates the user DB 318 to add the total of comeback gifts to the reward corresponding to the livestreamer ID of the target livestreamer.

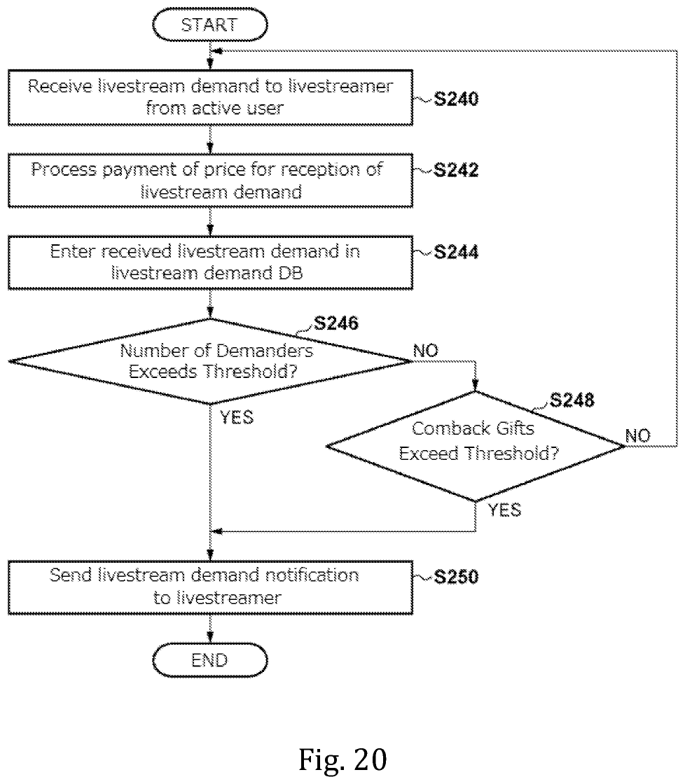

FIG. 20 is a flowchart showing a process related to a livestream demand performed in the livestreaming system 1. The livestream demand receiving unit 502 receives a livestream demand to a livestreamer from an active user (S240). The livestream demand receiving unit 502 receives a livestream demand entry request from the user terminal of the active user over the network NW.

In the case where the livestream demand is charged, the payment processing unit 310 processes the payment of the price for the reception of the livestream demand (S242). In the case where the livestream demand is free, step S242 is skipped. The payment processing unit 310 processes the payment of the price by the requesting active user in response to the reception of the livestream demand entry request. The payment processing unit 310 updates the user DB 318 to subtract the price points for the livestream demand from the points of the active user identified by the user ID included in the livestream demand entry request.

When the payment process of the price is completed in step S242, the livestream demand entry unit 504 enters the livestream demand received in step S240 in the livestream demand DB 510 (S244). In step S244, the total number of demanders and the livestream demander IDs are updated, and in addition, the total of comeback gifts is updated if the livestream demand is charged.

The livestream demand notification unit 506 determines whether or not the updated total number of demanders, which was updated for the target livestreamer in step S244, exceeds the threshold value (e.g., 10 or 30) (S246). If the updated total number of demanders exceeds the threshold value (YES in S246), the livestream demand notification unit 506 sends a livestream demand notification to the user terminal of the target livestreamer for which the total number of demanders was updated in step S244 (S250).

If the updated total number of demanders is equal to or less than the threshold value (NO in S246), the livestream demand notification unit 506 determines whether or not the updated total of comeback gifts, which was updated for the target livestreamer in step S244, exceeds the threshold value (e.g., 1000 or 10000) (S248). If the updated total of comeback gifts is equal to or less than the threshold value (NO in S248), the livestream demand receiving unit 502 enters a standby mode for another livestream demand, and the process returns to step S240. For a free livestream demand, the process also returns to step S240 in the same manner. If the updated total of comeback gifts exceeds the threshold value (YES in S248), the process proceeds to step S250.

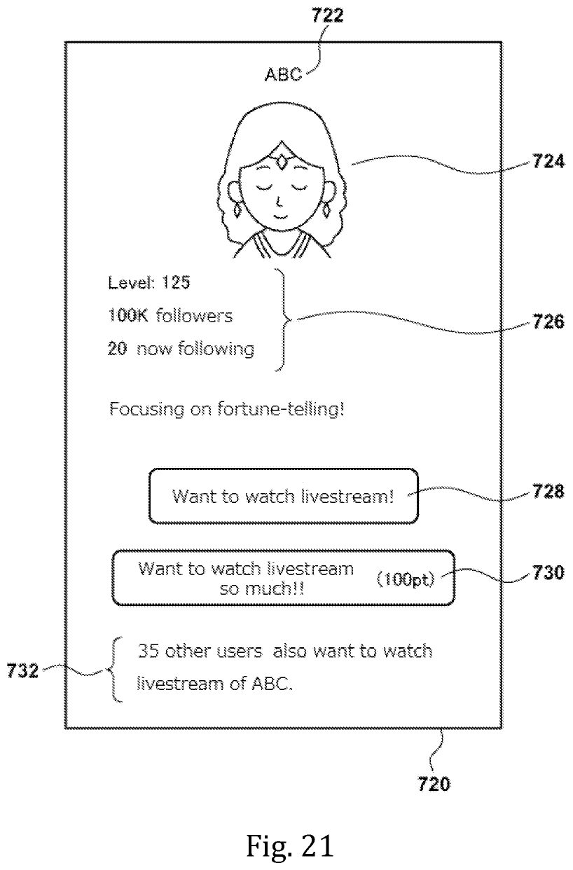

FIG. 21 is a representative screen image of a profile screen 720 displayed on the display of the active user's user terminal. The profile screen 720 contains the livestreamer ID 722 of the livestreamer whose profile is displayed, a thumbnail 724 of the livestreamer, the status 726 of the livestreamer on the livestreaming platform, a free livestream demand button 728, a charged livestream demand button 730, and text 732 that includes the total number of users who have submitted a livestream demand to the livestreamer up to the present, i.e., the total number of demanders. The free livestream demand button 728 and the charged livestream demand button 730 are examples of the livestream demand objects. The charged livestream demand button 730 includes a representation of the amount of price for the livestream demand.

When detecting a tap on the free livestream demand button 728 corresponding to a free livestream demand, the out-of-stream communication unit 404 generates a livestream demand entry request that includes the livestreamer ID of the livestreamer whose profile is displayed and the user ID of the active user who tapped the button, and sends it to the server 50 over the network NW. When detecting a tap on the charged livestream demand button 730 corresponding to a charged livestream demand, the out-of-stream communication unit 404 generates a livestream demand entry request that includes the livestreamer ID of the livestreamer whose profile is displayed, the user ID of the active user who tapped the button, and the information indicating the active user's acceptance of payment of the price, and sends it to the server 50 over the network NW.

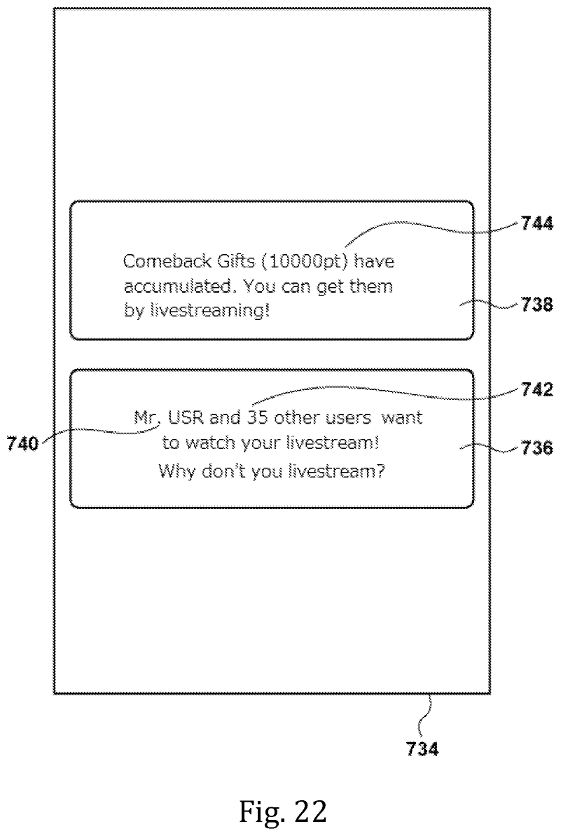

FIG. 22 is a representative screen image of a notification screen 734 displayed on the display of the livestreamer's user terminal. The notification screen 734 contains a first livestream demand notification 736 sent by the livestream demand notification unit 506 when the total number of demanders has exceeded the threshold value, and a second livestream demand notification 738 sent by the livestream demand notification unit 506 when the total of comeback gifts has exceeded the threshold value. The out-of-stream UI control unit 402 of the livestreamer's user terminal generates the notification screen 734 containing the first livestream demand notification 736 and/or the second livestream demand notification 738 received over the network NW, and displays the generated screen on the display.

The first livestream demand notification 736 corresponds to the livestream demand notification sent in step S250 of FIG. 20 when the total number of demanders has exceeded the threshold value in step S246. The first livestream demand notification 736 includes the total number 742 of users who have submitted a livestream demand to the livestreamer up to the present, i.e., the total number of demanders, and the livestream demander ID 740 of a representative livestream demander. The second livestream demand notification 738 corresponds to the livestream demand notification sent in step S250 of FIG. 20 when the total of comeback gifts has exceeded the threshold value in step S248. The second livestream demand notification 738 includes the total of comeback gifts 744 at the present.

When detecting a tap on the first livestream demand notification 736 or the second livestream demand notification 738, the out-of-stream communication unit 404 generates a notification to start a livestream and sends it to the server 50 over the network NW.

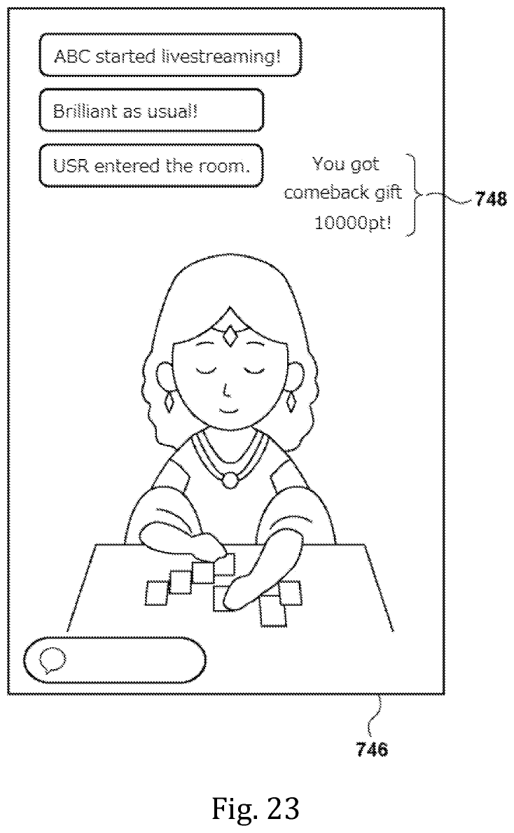

FIG. 23 is a representative screen image of the livestreaming room screen 746 shown on the display of the livestreamer's user terminal. When the livestreamer who has received the first livestream demand notification 736 or the second livestream demand notification 738 starts a livestream, the livestreaming room screen 746 is shown on the display of the livestreamer's user terminal. The configuration of the livestreaming room screen 746 is similar to that of the livestreaming room screen 650 in FIG. 12, except for the following point. The livestreaming room screen 746 contains a gift acquisition notification 748 that includes the total of comeback gifts awarded to the livestreamer who has resumed livestreaming.

In the livestreaming system 1 according to the embodiment, an active user can submit a livestream demand to a target livestreamer by simply selecting a livestream demand object on the target livestreamer's profile screen. In addition, the livestreamer can be motivated to perform a livestream by receiving a livestream demand notification from active users.

The Inventors, who have experience in operating a livestreaming platform, found that one of the reasons that a livestreamer who once stopped livestreaming resumes livestreaming is that he/she is asked to resume livestreaming by users who used to be his/her viewers. Another method is that the users who used to be his/her viewers use communication tools such as direct messaging to communicate their wishes to the livestreamer, but this can place a heavy burden on the livestreamer to communicate intensely with each of a large number of viewers. Therefore, in this embodiment, the livestream demand object is provided to implement the function of easily delivering to the livestreamer the voice of the users who used to be the livestreamer's viewers or other active users. This allows livestream demands of more viewers/active users to be communicated to the livestreamer while reducing the burden on the livestreamer. As a result, the livestreamer is inhibited or prevented from quitting livestreaming and guided toward resumption of livestreaming.

In the livestreaming system 1 according to the embodiment, the livestreamer is notified of an indicator indicating the magnitude of the demand for performing a livestream to the livestreamer. Thus, the livestreamer can decide whether or not to resume livestreaming based on the magnitude of the demand.

In the livestreaming system 1 according to the embodiment, the livestream demand object is shown when the length of the period for which the livestreamer has not been livestreaming exceeds the threshold value. Therefore, notification of a livestream demand can be made to a livestreamer who has not been livestreaming for a relatively long period. Furthermore, setting such a threshold value prevents the issue that a livestreamer who continues livestreaming receive a large number of livestream demand notifications. As a result, it is possible to encourage a livestreamer who has not been livestreaming for a relatively long period to resume livestreaming while reducing or eliminating the negative impact on a livestreamer who continues livestreaming.

In the livestreaming system 1 according to the embodiment, active users can submit a charged livestream demand, and a livestreamer who resumes livestreaming can receive a comeback gift according to the price for the demand. This allows active users who strongly demand resumption of the livestreaming can express the magnitude of their demands in the form of payment of the price. The presence of a comeback gift provides additional motivation for the target livestreamer to resume livestreaming, thus further encouraging the target livestreamer to resume livestreaming.

The configuration and operation of the livestreaming system according to the second embodiment have been described above. This embodiment is merely an example, and it will be understood by those skilled in the art that various modifications are possible by combining the respective components and processes, and that such modifications are also within the scope of the present disclosure.

It was described for this embodiment that a livestream demand notification is sent to a livestreamer when the total number of demanders exceeds the threshold value or when the total of comeback gifts exceeds the threshold value, but this is not limitative. For example, it is also possible that no threshold value is provided for the total number of demanders, and a livestream demand notification is sent each time a livestream demand is received. Alternatively, it is also possible that a threshold value is provided for the total number of demanders, while a livestream demand notification is sent each time a charged livestream demand is received. At this time, the user ID of the active user who submitted a charged livestream demand may be shown in the livestream demand notification. In this case, for a free livestream demand, a livestream demand notification is made on the condition that the total number of demanders exceeds the threshold value, while for a charged livestream demand, a livestream demand notification is made each time the charged livestream demand is submitted. This allows for a difference in effectiveness between a charged livestream demand and a free livestream demand. Alternatively, it is also possible that several different threshold values are provided. For example, there could be three threshold values for the total number of demanders: 100, 300, and 1000. In this case, as the total number of demanders increases, the livestream demand notifications are made three times in total.

It was described for this embodiment that reception of a livestream demand triggers sending of a livestream demand notification, but this is not limitative. For example, it is also possible that the livestream demand notification unit 506 refers to the livestream demand DB 510 periodically, such as hourly or daily, and sends livestream demand notifications to target livestreamers who satisfy the conditions.

It was described for this embodiment that the total of comeback gifts is awarded to a target livestreamer on the condition that the livestreamer resumes livestreaming, but this is not limitative. It is also possible that the total of comeback gifts is awarded stepwise according to the livestreaming time and the number of viewers. For example, it is possible that 5% of the total of comeback gifts is awarded to the target livestreamer when the target livestreamer resumes livestreaming, and 3% for each additional viewer thereafter. Alternatively, it is also possible that a predetermined amount of gift is awarded per minute of livestreaming time until the total of comeback gifts is reached. In this case, it is possible to prevent the target livestreamer from terminating livestreaming immediately after resuming it to collect the total of comeback gifts.

It was described for this embodiment that the first livestream demand notification 736 and the second livestream demand notification 738 are separate, but this is not limitative. These two notifications may be combined into one. For example, it is possible that a livestream demand notification may be provided that includes the total number of demanders and the total of comeback gifts.

The technical ideas according to the first and second embodiments may be applied to live commerce or virtual livestreaming using an avatar that moves in synchronization with the movement of the livestreamer instead of the image of the livestreamer.

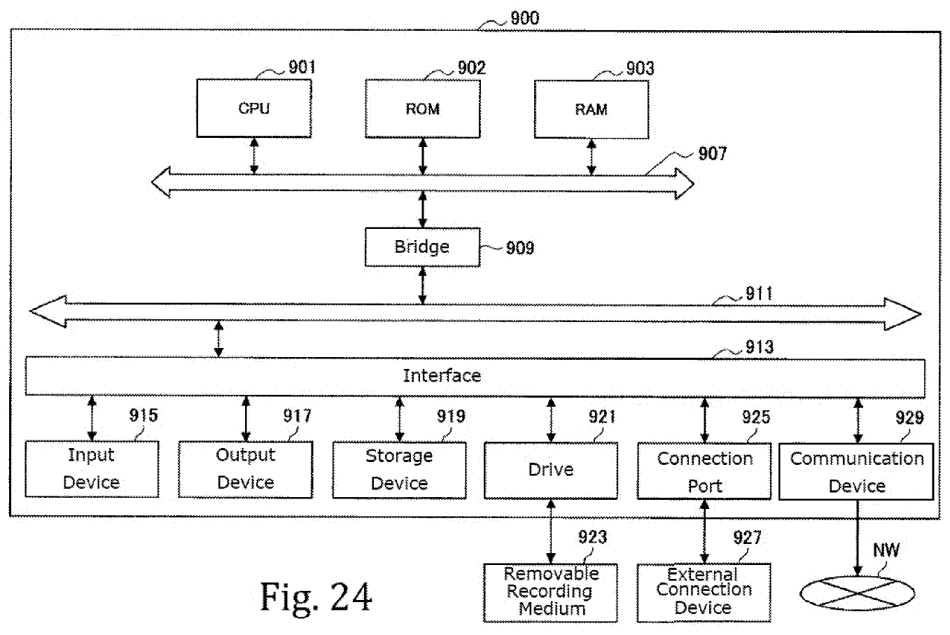

Referring to FIG. 24, the hardware configuration of an information processing device according to the first embodiment will be now described. FIG. 24 is a block diagram showing an example of a hardware configuration of an information processing device according to the first embodiment. The illustrated information processing device 900 may, for example, realize the server 10 and the user terminals 20 and 30 in the first embodiment. The server 50 and the user terminals in the second embodiment have the same hardware configuration.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a processing circuit such as a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the first embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, the superimposition of a predetermined frame image on an image of the video data performed by the viewer's user terminal may be performed by the server 10 or may be performed by the livestreamer's user terminal.

What is claimed is:

1. A server, comprising:
a first receiving unit for receiving, from a terminal over a network, an input content entered on the terminal by a user, the input content being associated with a livestreamer of a livestream, the input content being representative of a matter that the user wants the livestreamer to do;
an entry unit for entering the received matter that the user wants the livestreamer to do in a wish list associated with the livestreamer; and
a notification unit for notifying the wish list to the livestreamer.

2. The server of claim 1, wherein the notification unit notifies, along with the matter that the user wants the livestreamer to do entered in the wish list, an indicator indicating a magnitude of support for the matter.

3. The server of claim 1, wherein the first receiving unit receives the input content as the matter that the user wants the livestreamer to do, on a condition of payment or acceptance of payment by the user.

4. The server of claim 2, further comprising a second receiving unit for receiving, from another user over the network, a support for the matter that the user wants the livestreamer to do.

5. The server of claim 4, wherein the second receiving unit receives the support from the other user on a condition of payment or acceptance of payment by the other user.

6. The server of claim 5,
wherein the indicator indicating the magnitude of support is a number of supports, and
wherein a larger number of supports are added as a larger price is paid.

7. The server of claim 4, wherein when receiving the support from the other user, the second receiving unit presents, to the other user, one or more user IDs of one or more users who have supported the matter that the user wants the livestreamer to do.

8. The server of claim 4, wherein when receiving the support from the other user, the second receiving unit enables sharing by the other user for seeking support for the matter that the user wants the livestreamer to do.

9. The server of claim 1,
wherein the first receiving unit receives the input content during the livestream,
wherein the entry unit performs an entry process during the livestream, and
wherein the notification unit performs a notification process during the livestream.

10. The server of claim 1, further comprising a schedule notification unit for notifying, upon generation of a schedule of a livestream corresponding to the matter that the user wants the livestreamer to do, the schedule to users who have supported the matter.

11. A method comprising the steps of:
receiving, by a server from a terminal over a network, an input content entered on the terminal by a user, the input content being associated with a livestreamer of a livestream, the input content being representative of a matter that the user wants the livestreamer to do;
entering, by the server, the received matter that the user wants the livestreamer to do in a wish list associated with the livestreamer; and
notifying, by the server, the wish list to the livestreamer.

12. The method of claim 11, wherein the step of notifying comprises notifying, along with the matter that the user wants the livestreamer to do entered in the wish list, an indicator indicating a magnitude of support for the matter.

13. The method of claim 11, wherein the step of receiving comprises receiving the input content as the matter that the user wants the livestreamer to do, on a condition of payment or acceptance of payment by the user.

14. The method of claim 12, further comprising another step of receiving, from another user over the network, a support for the matter that the user wants the livestreamer to do.

15. The method of claim 14, wherein the other step of receiving comprises receiving the support from the other user on a condition of payment or acceptance of payment by the other user.

16. The method of claim 15,
wherein the indicator indicating the magnitude of support is a number of supports, and
wherein a larger number of supports are added as a larger price is paid.

17. The method of claim 14, wherein the other step of receiving further comprises presenting, to the other user, one or more user IDs of one or more users who have supported the matter that the user wants the livestreamer to do.

18. The method of claim 14, wherein the other step of receiving further comprises enabling sharing by the other user for seeking support for the matter that the user wants the livestreamer to do.

19. The method of claim 11,
wherein the step of receiving comprises receiving the input content during the livestream,
wherein the step of entering comprises performing an entry process during the livestream, and
wherein the step of notifying comprises performing a notification process during the livestream.

20. The method of claim 11, further comprising the step of notifying, upon generation of a schedule of a livestream corresponding to the matter that the user wants the livestreamer to do, the schedule to users who have supported the matter.
